(19) United States
(12) Patent Application Publication
(10) Pub. No.: US 2026/0210428 A1
(43) Pub. Date: Jul. 23, 2026

(54) TRANSMISSION MECHANISM HAVING HOURGLASS ENVELOPING WORM AND HELICAL GEAR

(71) Applicant: Talls Intelligent Technology (Shenzhen) Co., Ltd., Shenzhen (CN)

(72) Inventors: Yulong TAO, Shenzhen (CN); Lei TAO, Shenzhen (CN); Yangyang LI, Shenzhen (CN); Zekai TAO, Shenzhen (CN)

(73) Assignee: Talls Intelligent Technology (Shenzhen) Co., Ltd., Shenzhen (CN)

(21) Appl. No.: 19/430,792

(22) Filed: Dec. 23, 2025

(30) Foreign Application Priority Data
Jan. 20, 2025 (CN) 202510083445.9

(51) Int. Cl. F16H 19/08; F16H 57/021; F16H 57/029; F16H 57/039; F16H 57/02

(52) U.S. Cl. CPC F16H 19/08; F16H 57/021; F16H 57/029; F16H 57/039; F16H 2057/02034; F16H 2057/02073; F16H 2057/0213

(57) ABSTRACT

A transmission mechanism having an hourglass enveloping worm and a helical gear includes: a shell, a helical gear, a protective column, and an hourglass enveloping worm. The shell includes a first cavity and a second cavity inside. The helical gear is rotatably provided in the first cavity. The protective column is rotatably provided in the second cavity, the protective column includes a placement cavity and a clearance opening communicating the first cavity and the second cavity. An axis of the protective column is parallel to an axis of the placement cavity, the protective column is provided with a limiting mechanism, the limiting mechanism is connected to the protective column and the shell to restrict lateral movement of the protective column. The hourglass enveloping worm is rotatably provided in the placement cavity, an axis of the hourglass enveloping worm and the axis of the placement cavity are collinear.

### CROSS-REFERENCE TO RELATED APPLICATIONS

This application claims priority to Chinese Patent Application No. 202510083445.9, filed on January 20, 2025, the entire contents of which are incorporated herein by reference.

### TECHNICAL FIELD

The present application relates to the technical field of robotics, and in particular to a transmission mechanism having an hourglass enveloping worm and a helical gear.

### BACKGROUND

The transmission mechanism having the hourglass enveloping worm and the helical gear is a common mechanical transmission device for transmitting motion and power between two intersecting shafts. It is often used in applications with large transmission ratios, low transmission power, or intermittent operation. In the meshing mid-plane of the helical gear and the hourglass enveloping worm, the helical gear is equivalent to a gear and the hourglass enveloping worm is equivalent to a rack, and the hourglass enveloping worm is also similar in shape to a screw. The two shafts in the transmission mechanism typically have a crossing angle of 90º, and the hourglass enveloping worm is generally the driving component. During operation, the helical gear teeth slide and roll along the helical surface of the hourglass enveloping worm. The existing transmission mechanisms having the hourglass enveloping worm and the helical gear, the center distance between the helical gear and the hourglass enveloping worm is relatively fixed, this design mainly relies on machining accuracy to reduce clearance.

However, during use, due to assembly and dimensional deviations, clearances are prone to occur in existing transmission mechanism having the hourglass enveloping worm and the helical gears, affecting transmission accuracy and stability.

### SUMMARY

The present application is to provide a transmission mechanism having an hourglass enveloping worm and a helical gear, which aims to reduce the clearance between the helical gear and the hourglass enveloping worm in the transmission mechanism.

For the above objectives, the present application provides a transmission mechanism having the hourglass enveloping worm and the helical gear, and the transmission mechanism having the hourglass enveloping worm and the helical gear includes: a shell; a helical gear; a protective column; and an hourglass enveloping worm.

The shell includes a first cavity and a second cavity inside, the first cavity is communicated with the second cavity; the helical gear is rotatably provided in the first cavity; the protective column is rotatably provided in the second cavity, the protective column includes a placement cavity and a clearance opening communicating the first cavity and the second cavity; an axis of the protective column is parallel to an axis of the placement cavity, the protective column is provided with a limiting mechanism, the limiting mechanism is connected to the protective column and the shell to restrict a lateral movement of the protective column; and

the hourglass enveloping worm is rotatably provided in the placement cavity, an axis of the hourglass enveloping worm and the axis of the placement cavity are collinear; the hourglass enveloping worm is at least partially exposed in the clearance opening to mesh with the helical gear; and a rotation of the protective column causes the hourglass enveloping worm to move toward or away from the helical gear along a circumferential direction of the protective column.

In an embodiment, the limiting mechanism includes a limiting rib and a limiting groove provided in the second cavity, one end of the limiting rib is connected to the protective column, and the other end of the limiting rib extends to the limiting groove, the protective column includes a first bushing and a second bushing, the first bushing is rotatably connected to one end of the hourglass enveloping worm, the second bushing is rotatably connected to the other end of the hourglass enveloping worm, the first bushing is provided with a first limiting part, the second bushing is provided with a second limiting part, the second limiting part is fixedly connected to the first limiting part to cause the first bushing to rotate with the second bushing, and the first limiting part and the second limiting part form the limiting rib, the limiting rib cooperates with the limiting groove to position the first bushing and the second bushing.

In an embodiment, the first bushing includes a first bushing body, a first protrusion connected to the first bushing body, and a second protrusion connected to the first protrusion, the first protrusion and the second protrusion form the first limiting part;

the second bushing includes a second bushing body, a third protrusion provided at the second bushing body, and a recess provided at the third protrusion, the third protrusion and the recess form the second limiting part; and

the first protrusion is end face-fitted with the third protrusion, and the second protrusion is end face-fitted with the recess.

In an embodiment, one end of the shell is provided with a receiving cavity communicating with the second cavity, and the second bushing further includes a fourth protrusion provided at the second bushing body, the fourth protrusion and the third protrusion are provided at opposite sides of the second bushing body, the fourth protrusion cooperates with the receiving cavity to position the second bushing.

In an embodiment, the transmission mechanism further includes a brushless motor. The fourth protrusion is provided with a threaded hole, the brushless motor is threadedly connected to the threaded hole, and the brushless motor is drivingly connected to the hourglass enveloping worm to drive the hourglass enveloping worm to rotate.

In an embodiment, the brushless motor includes a motor body, an output shaft connected to the motor body, and a threaded post sleeved on the output shaft, the output shaft is drivingly connected to the hourglass enveloping worm, and the threaded post is threadedly connected to the threaded hole.

In an embodiment, the transmission mechanism further includes a gear shaft. The shell is provided with an output hole communicating with the first cavity, the gear shaft is rotatably provided in the output hole, one end of the gear shaft is fixedly connected to the helical gear, and the other end of the gear shaft is exposed on an outside of the shell and is provided with an output portion.

In an embodiment, a bearing is provided in the output hole, the bearing includes an inner ring and an outer ring, and the gear shaft passes through the inner ring.

In an embodiment, the transmission mechanism further includes a sealing ring. The sealing ring is provided in the output hole, and the gear shaft passes through the sealing ring.

In an embodiment, the shell includes a first shell and a second shell, and the first shell is fixedly connected to the second shell by bolts.

In the technical solution of the present application, the shell provides overall support for the transmission mechanism having the hourglass enveloping worm and the helical gear. The shell includes a first cavity and a second cavity inside, and the first cavity is communicated with the second cavity, allowing the helical gear and the hourglass enveloping worm to be placed in the first cavity and the second cavity. The helical gear is the driven component in the transmission mechanism, while the hourglass enveloping worm is the driving component. Motion transmission is achieved through the meshing of the helical gear and the hourglass enveloping worm. In the embodiment, a protective column is provided, and the hourglass enveloping worm is mounted in the placement cavity. By driving the protective column to rotate, the hourglass enveloping worm can move along the circumferential direction of the protective column, thereby moving closer to the helical gear to reduce clearance. Since the axis of the protective column is parallel to and spaced apart from the axis of the placement cavity, when the protective column rotates, the placement cavity will also rotate. Because the axis of the placement cavity and the axis of the hourglass enveloping worm are collinear, the position of the hourglass enveloping worm within the placement cavity will not change. However, the rotation of the protective column will change the position of the hourglass enveloping worm relative to the helical gear, thereby reducing the clearance between the helical gear and the hourglass enveloping worm. In an embodiment, a limiting mechanism is provided at the protective column, the limiting mechanism is connected to the protective column and the shell to restrict the lateral movement of the protective column and ensuring that the protective column can only rotate along the axial direction thus improving the accuracy and stability of the transmission.

### BRIEF DESCRIPTION OF THE DRAWINGS

To more clearly illustrate the technical solutions in the embodiments of the present application or the related art, the drawings used in the description of the embodiments or the related art will be briefly introduced below. Obviously, the drawings described below are only some embodiments of the present application. For those skilled in the art, other drawings can be obtained based on the structures shown in these drawings without creative effort.

FIG. 1 is a structural schematic diagram of a transmission mechanism having an hourglass enveloping worm and a helical gear according to an embodiment of the present application.

FIG. 2 is a cross-sectional structural schematic diagram of the transmission mechanism having the hourglass enveloping worm and the helical gear according to an embodiment of the present application.

FIG. 3 is a structural schematic diagram of a protective column according to an embodiment of the present application.

FIG. 4 is an exploded schematic diagram of the protective column according to an embodiment of the present application.

FIG. 5 is a structural schematic diagram of a brushless motor according to an embodiment of the present application.

The realization of the purpose, functional features and advantages of the present application will be further explained in conjunction with the embodiments and with reference to the accompanying drawings.

### DETAILED DESCRIPTION OF THE EMBODIMENTS

The technical solutions of the embodiments of the present application will be clearly and completely described below with reference to the accompanying drawings. Obviously, the described embodiments are only one part of the embodiments of the present application, and not all of the embodiments. Based on the embodiments of the present application, all other embodiments obtained by those skilled in the art without creative effort are within the scope of protection of the present application.

It should be noted that if the embodiments of the present application involve directional indicators (such as up, down, left, right, front, rear, etc.), the directional indicators are only used to explain the relative positional relationship and movement of the components in a specific posture. If the specific posture changes, the directional indicators will also change accordingly.

In an embodiment, if the embodiments of the present application involve descriptions such as “first” or “second” these descriptions are for descriptive purposes only and should not be construed as indicating or implying their relative importance or implicitly specifying the number of technical features indicated. Thus, a feature defined with “first” or “second” may explicitly or implicitly include at least one of those features. Additionally, the use of “and/or” or “and/or” throughout the text includes three parallel solutions. For example, “A and/or B” includes solution A, solution B, or a solution where both A and B are satisfied simultaneously. In an embodiment, the technical solutions of the various embodiments can be combined with each other, but this must be based on the ability of those skilled in the art to implement them. When the combination of technical solutions is contradictory or impossible to implement, it should be considered that such a combination of technical solutions does not exist and is not within the scope of protection claimed by the present application.

In a transmission mechanism having an hourglass enveloping worm and a helical gear, the helical gear teeth slide and roll along the helical surface of the hourglass enveloping worm during operation. Due to assembly and dimensional deviations, clearance easily occurs in existing transmission mechanism having an hourglass enveloping worm and a helical gear, and thereby affecting transmission accuracy and stability. If the clearance is too large, it will lead to decreased transmission accuracy, increased positioning errors, and reduced transmission efficiency. This not only increases energy consumption but may also affect the long-term operating efficiency of the device.

In view of this, the present application provides a transmission mechanism having an hourglass enveloping worm and a helical gear. By providing a protective column with an eccentric placement cavity, the protective column is rotatably connected to the shell. Since the axis of the hourglass enveloping worm and the axis of the protective column are spaced apart, when the protective column is driven to rotate around its own axis, it can drive the hourglass enveloping worm to move toward the helical gear, so that the helical gear and the hourglass enveloping worm are brought into tight engagement.

To better understand the above technical solution, the following detailed explanation is provided in conjunction with the accompanying drawings.

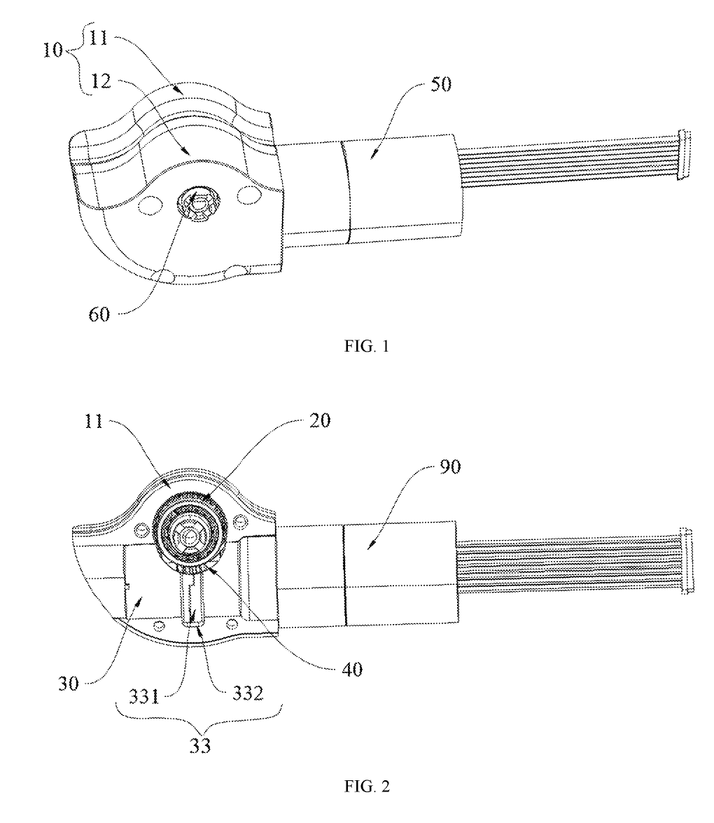

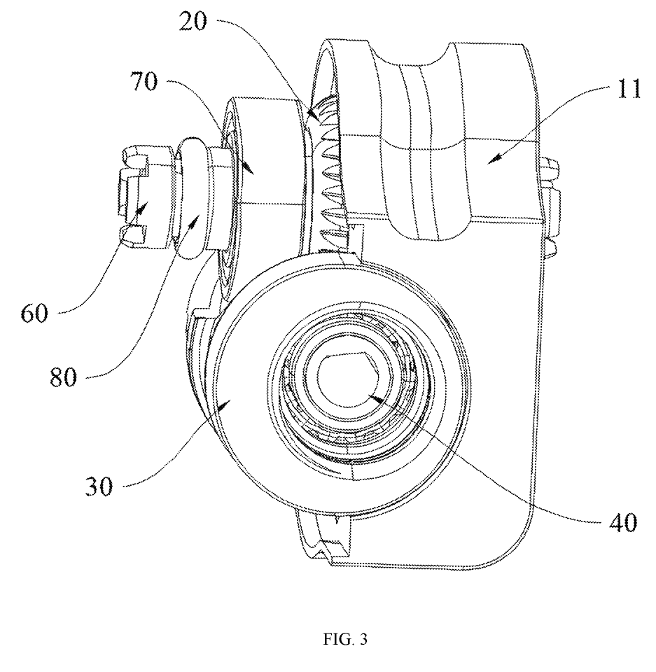

As shown in FIG. 1, FIG. 2, and FIG. 3, the present application provides a transmission mechanism having an hourglass enveloping worm and a helical gear, the transmission mechanism having an hourglass enveloping worm and a helical gear includes: a shell 10; a helical gear 20; a protective column 30; and an hourglass enveloping worm 40.

The shell 10 includes a first cavity and a second cavity inside, and the first cavity is communicated with the second cavity.

The helical gear 20 is rotatably provided in the first cavity.

The protective column 30 is rotatably provided in the second cavity. The protective column 30 includes a placement cavity and a clearance opening communicating the first cavity and second cavity. The axis of the protective column 30 is parallel to and spaced apart from the axis of the placement cavity. The protective column 30 is provided with a limiting mechanism 33, the limiting mechanism 33 is connected to the protective column 30 and the shell 10 to restrict the lateral movement of the protective column 30.

The hourglass enveloping worm 40 is rotatably provided in the placement cavity. The axis of the hourglass enveloping worm 40 and the axis of the placement cavity are collinear, and the hourglass enveloping worm 40 is at least partially exposed in the clearance opening to mesh with the helical gear 20. The rotation of the protective column 30 causes the hourglass enveloping worm 40 to move along the circumferential direction of the protective column 30 toward or away from the helical gear 20.

In the embodiment, the shell 10 provides overall support for the transmission mechanism having an hourglass enveloping worm and a helical gear. The shell 10 includes a first cavity and a second cavity inside, and the first cavity is communicated with the second cavity, allowing the helical gear 20 and the hourglass enveloping worm 40 to be placed in the first cavity and the second cavity. The helical gear 20 is the driven component in the transmission mechanism, while the hourglass enveloping worm 40 is the driving component. Motion transmission is achieved through the meshing of the helical gear 20 and the hourglass enveloping worm 40. In the embodiment, a protective column 30 is provided, and the hourglass enveloping worm 40 is mounted in the placement cavity. By driving the protective column 30 to rotate, the hourglass enveloping worm 40 can move along the circumferential direction of the protective column 30, thereby moving closer to the helical gear 20 to reduce clearance. Since the axis of the protective column 30 is parallel to and spaced apart from the axis of the placement cavity, when the protective column 30 rotates, the placement cavity will also rotate. Because the axis of the placement cavity and the axis of the hourglass enveloping worm 40 are collinear, the position of the hourglass enveloping worm 40 within the placement cavity will not change. However, the rotation of the protective column 30 will change the position of the hourglass enveloping worm 40 relative to the helical gear 20, thereby reducing the clearance between the helical gear 20 and the hourglass enveloping worm 40. In an embodiment, a limiting mechanism 33 is provided at the protective column 30, the limiting mechanism 33 is connected to the protective column 30 and the shell 10 to restrict the lateral movement of the protective column 30 and ensuring that the protective column 30 can only rotate along the axial direction thus improving the accuracy and stability of the transmission.

In an embodiment, the transmission mechanism having the hourglass enveloping worm and the helical gear includes a shell 10, a helical gear 20, a protective column 30, and an hourglass enveloping worm 40.

The shell 10 is typically made of metal and has sufficient strength and rigidity to ensure the stability and durability of the transmission mechanism having the hourglass enveloping worm and the helical gear. The first cavity is configured to accommodate the helical gear 20, and a second cavity is configured to accommodate the protective column 30 and the hourglass enveloping worm 40.

The helical gear 20 is typically made of wear-resistant material to reduce wear. The helical gear 20 is rotatably provided in the first cavity and can mesh with the hourglass enveloping worm 40 to achieve a transmission effect. It should be noted that the tooth profile design of the hourglass enveloping worm 40 needs to match the tooth profile of the helical gear 20 to ensure good meshing performance.

The protective column 30 is configured to adjust the position of the hourglass enveloping worm 40, thereby adjusting the clearance between the helical gear 20 and the hourglass enveloping worm 40. The protective column 30 is provided in the second cavity, and the protective column 30 includes a placement cavity inside for placing the hourglass enveloping worm 40. In an embodiment, the axis of the protective column 30 is parallel to and spaced apart from the axis of the placement cavity, while the axis of the hourglass enveloping worm 40 is collinear with the axis of the placement cavity. Thus, when the protective column 30 is driven to rotate, the relative position of the hourglass enveloping worm 40 and the helical gear 20 changes. By adjusting the rotation angle of the protective column 30, the size of the clearance between the hourglass enveloping worm 40 and the helical gear 20 can be controlled. It is understood that a larger rotation angle results in a smaller clearance between the helical gear 20 and the hourglass enveloping worm 40, and a smaller rotation angle results in a larger clearance between the helical gear 20 and the hourglass enveloping worm 40. By providing a clearance opening on the protective column 30 communicating the first cavity and the second cavity, and the size of the clearance opening being larger than the maximum displacement of the protective column 30 during rotation of the protective column 30, at least part of the hourglass enveloping worm 40 can be exposed to mesh with the helical gear 20. The protective column 30 can be a one-piece structure to improve adjustment accuracy, or it can be a split structure to facilitate the mounting of the hourglass enveloping worm 40 within the placement cavity of the protective column 30. The rotation of the protective column 30 can be driven by an external motor or achieved manually, which is not limited herein. The limiting mechanism 33 can be one or more limiting blocks, fixed on the protective column 30, and cooperate with the inner wall of the shell 10 or a specific limiting groove. The inner wall of the shell 10 can be provided with a limiting groove that matches the limiting block. The limiting groove is provided along the rotation direction of the protective column 30. One end of the limiting mechanism 33 is connected to the protective column 30, and the other end of the limiting mechanism 33 is provided in the limiting groove. The limiting groove has two groove walls that are opposite to each other along the axial direction of the protective column 30. The end of the limiting mechanism 33 away from the protective column 30 is rotatably provided in the limiting groove and is abutted against the two groove walls, thereby restricting the lateral movement of the protective column 30.

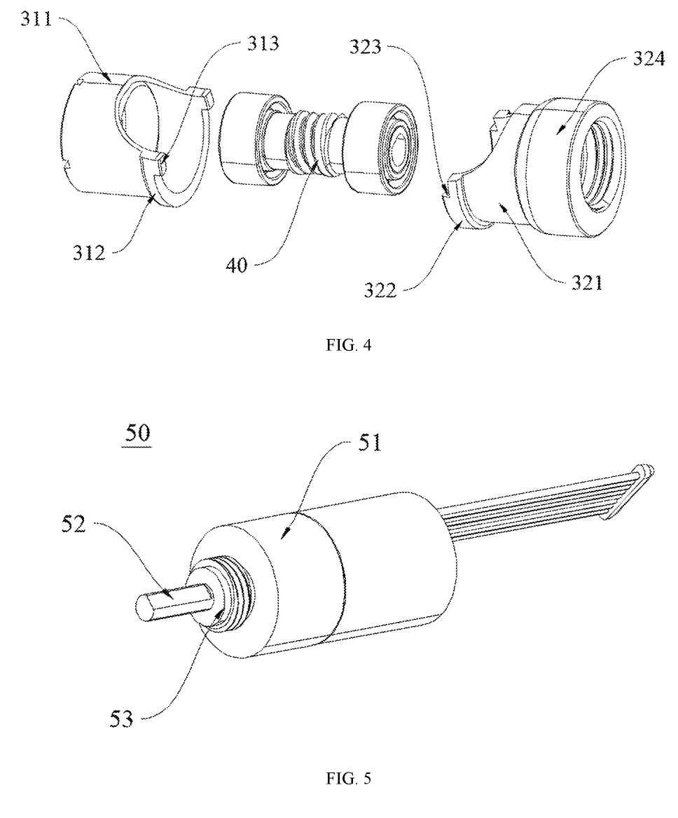

As shown in FIG. 2 and FIG. 4, in an embodiment of the present application, the limiting mechanism 33 includes a limiting rib 331 and a limiting groove 332 provided in the second cavity. One end of the limiting rib 331 is connected to the protective column 30, and the other end of the limiting rib 331 extends to the limiting groove 332. The protective column 30 includes a first bushing 31 and a second bushing 32. The first bushing 31 is rotatably connected to one end of the hourglass enveloping worm 40, and the second bushing 32 is rotatably connected to the other end of the hourglass enveloping worm 40. The first bushing 31 is provided with a first limiting part, and the second bushing 32 is provided with a second limiting part. The second limiting part is fixedly connected to the first limiting part to cause the first bushing 31 to rotate with the second bushing 32. The first limiting part and the second limiting part form the limiting rib 331. The limiting rib 331 cooperates with the limiting groove 332 to position the first bushing 31 and the second bushing 32.

In the technical solution adopted in the embodiment, the protective column 30 may further include a first bushing 31 and a second bushing 32. A limiting groove 332 is provided in the second cavity. In the embodiment, one of the first limiting part and the second limiting part is provided with a slot and the other is provided with a block. The slot is engaged with the block to fix the first limiting part and the second limiting part. The first bushing 31 is sleeved from one end of the hourglass enveloping worm 40, and the second bushing 32 is sleeved from the other end of the hourglass enveloping worm 40. When the end of the first bushing 31 adjacent to the second bushing 32 is abutted against the second bushing 32, the slot is engaged with the block, so that when the second bushing 32 rotates, the first bushing 31 can be subjected to force and rotate synchronously with the second bushing 32. The first limiting part and the second limiting part together form a limiting rib 331. The limiting rib 331 cooperates with the limiting groove 332 to effectively restrict the lateral movement of the protective column 30, ensuring that the protective column 30 can only rotate along the axial direction, thereby improving the accuracy and stability of the hourglass enveloping worm 40 during the adjustment process.

As shown in FIG. 2 and FIG. 4, in an embodiment of the present application, the first bushing 31 includes a first bushing body 311, a first protrusion 312 connected to the first bushing body 311, and a second protrusion 313 connected to the first protrusion 312, the first protrusion 312 and the second protrusion 313 form a first limiting part.

The second bushing 32 includes a second bushing body 321, a third protrusion 322 provided at the second bushing body 321, and a recess 323 provided at the third protrusion 322. The third protrusion 322 and the recess 323 form a second limiting part.

The first protrusion 312 is end face-fitted with the third protrusion 322, and the second protrusion 313 is end face-fitted with the recess 323.

In the embodiment, the first bushing 31 may further include a first bushing body 311, a first protrusion 312, and a second protrusion 313. Correspondingly, the second bushing 32 may further include a second bushing body 321, a third protrusion 322, and a recess 323. In the embodiment, the first protrusion 312 and the third protrusion 322 cooperate to restrict the lateral movement of the protective column 30. The second protrusion 313 and the recess 323 cooperate to achieve synchronous rotation of the first bushing 31 and the second bushing 32. It is understood that the first protrusion 312 and the third protrusion 322 can tightly fit against the side walls of the limiting groove 332, effectively restricting the lateral movement of the protective column 30. When the second bushing body 321 rotates, the second protrusion 313 and the recess 323 can transmit the rotational force borne by the second bushing 32 to the first bushing body 311, causing the first bushing body 311 to rotate with the second bushing body 321

As shown in FIG. 2 and FIG. 4, in an embodiment of the present application, one end of the shell 10 is provided with a receiving cavity communicating with the second cavity, and the second bushing 32 further includes a fourth protrusion 324 provided at the second bushing body 321. The fourth protrusion 324 and the third protrusion 322 are provided at opposite sides of the second bushing body 321, and the fourth protrusion 324 cooperates with the receiving cavity to position the second bushing 32.

In the embodiment, the second bushing 32 may further include a fourth protrusion 324. The shell 10 is provided with a receiving cavity. In the embodiment, the fourth protrusion 324 is mounted within the receiving cavity, enabling more precise positioning. This also improves the structural strength of the second bushing 32, making it easier for the second bushing 32 to withstand force and rotate. In an embodiment, it provides a larger contact area and more stable connection points, facilitating connection with other mechanical components or structures and enhancing the overall stability and reliability of the structure.

As shown in FIG. 2 and FIG. 3, in an embodiment of the present application, the transmission mechanism having the hourglass enveloping worm and the helical gear further includes a brushless motor 50. The fourth protrusion 324 is provided with a threaded hole. The brushless motor 50 is threadedly connected to the threaded hole, and the brushless motor 50 is drivingly connected to the hourglass enveloping worm 40 to drive the hourglass enveloping worm 40 to rotate.

In the embodiment, the brushless motor 50 provides rotational power to the hourglass enveloping worm 40, causing the hourglass enveloping worm 40 to drive the helical gear 20 to rotate, thus achieving motion transmission. The brushless motor 50 has advantages such as high efficiency, low noise, and long lifespan, enabling precise driving of the hourglass enveloping worm 40. In an embodiment, the fourth protrusion 324 can be fixed to the brushless motor 50 via a threaded hole, reducing the possibility of changes in the clearance between the helical gear 20 and the hourglass enveloping worm 40 due to loosening of the second bushing 32 and the first bushing 31 during operation.

As shown in FIG. 2 and FIG. 5, in an embodiment of the present application, the brushless motor 50 includes a motor body 51, an output shaft 52 connected to the motor body 51, and a threaded post 53 sleeved on the output shaft 52. The output shaft 52 is drivingly connected to the hourglass enveloping worm 40, and the threaded post 53 is threadedly connected to the threaded hole.

In the embodiment, the brushless motor 50 may further include a motor body 51, an output shaft 52, and a threaded post 53. In the embodiment, the motor body 51 is the main body of the brushless motor 50 and provides power. The output shaft 52 is connected to the motor body 51 and transmits power to drive the hourglass enveloping worm 40 to rotate. The threaded post 53 is sleeved on the output shaft 52 and threadedly connected to the second bushing 32 through a threaded hole. This ensures the stability of the first bushing 31 and the second bushing 32 during the rotation of the hourglass enveloping worm 40, reducing the possibility of loosening or vibration of the first bushing 31 and the second bushing 32 during rotation, which could cause changes in the clearance between the helical gear 20 and the hourglass enveloping worm 40, thus improving the reliability of the transmission mechanism having the hourglass enveloping worm and the helical gear.

As shown in FIG. 1 and FIG. 3, in an embodiment of the present application, the transmission mechanism having the hourglass enveloping worm and the helical gear further includes a gear shaft 60. The shell 10 is provided with an output hole communicating with the first cavity. The gear shaft 60 is rotatably provided in the output hole. One end of the gear shaft 60 is fixedly connected to the helical gear 20, and the other end of the gear shaft 60 is exposed on the outside of the shell 10 and is provided with an output portion.

In the technical solution adopted in the embodiment, the rotational motion of the helical gear 20 can be conveniently transmitted to an external device through the gear shaft 60. One end of the gear shaft 60 is fixedly connected to the helical gear 20, and the other end of the gear shaft 60 is exposed on the outside of the shell 10 and connected to the external device through the output portion, thereby realizing that the external device rotates synchronously with the helical gear 20.

As shown in FIG. 3, in an embodiment of the present application, a bearing 70 is provided in the output hole, the bearing 70 includes an inner ring and an outer ring, and the gear shaft 60 passes through the inner ring.

In the embodiment, the bearing 70 improves the smoothness of the rotation of the gear shaft 60, ensuring the stable rotation of the gear shaft 60. The inner and outer rings of the bearing 70 work together to achieve high-precision, low-friction transmission. It should be noted that the outer ring is in interference fit with the output hole to ensure the stability of the bearing 70.

As shown in FIG. 3, in an embodiment of the present application, the transmission mechanism having the hourglass enveloping worm and the helical gear further includes a sealing ring 80, the sealing ring 80 is provided in the output hole, and the gear shaft 60 passes through the sealing ring 80.

In the technical solution adopted in the embodiment, the sealing ring 80 can reduce the entry of external dust and impurities into the shell 10, keep the inside clean, improve safety, and extend the service life of the transmission mechanism having the hourglass enveloping worm and the helical gear.

As shown in FIG. 1, in an embodiment of the present application, the shell 10 includes a first shell 11 and a second shell 12, the first shell 11 is fixedly connected to the second shell 12 by bolts.

In the technical solution adopted in the embodiment, the shell 10 may further include a first shell 11 and a second shell 12. In the embodiment, the first shell 11 and the second shell 12 are symmetrically provided along the axis of the hourglass enveloping worm 40 and are fixedly connected by bolts, which makes the assembly and disassembly of the helical gear 20, the hourglass enveloping worm 40 and the protective column 30 more convenient and reduces maintenance costs.

The above is merely an exemplary embodiment of the present application and does not limit the patent scope of the present application. Any equivalent structural transformations made using the contents of the present application specification and drawings under the technical concept of the present application, or direct/indirect applications in other related technical fields, are included within the patent protection scope of the present application.

What is claimed is:

1. A transmission mechanism having an hourglass enveloping worm and a helical gear, comprising:
a shell;
a helical gear;
a protective column; and
an hourglass enveloping worm,
wherein the shell comprises a first cavity and a second cavity inside, the first cavity is communicated with the second cavity;
the helical gear is rotatably provided in the first cavity;
the protective column is rotatably provided in the second cavity, the protective column comprises a placement cavity and a clearance opening communicating the first cavity and the second cavity; an axis of the protective column is parallel to an axis of the placement cavity, the protective column is provided with a limiting mechanism, the limiting mechanism is connected to the protective column and the shell to restrict a lateral movement of the protective column; and
the hourglass enveloping worm is rotatably provided in the placement cavity, an axis of the hourglass enveloping worm and the axis of the placement cavity are collinear; the hourglass enveloping worm is at least partially exposed in the clearance opening to mesh with the helical gear; and a rotation of the protective column causes the hourglass enveloping worm to move toward or away from the helical gear along a circumferential direction of the protective column.

2. The transmission mechanism having the hourglass enveloping worm and the helical gear according to claim 1, wherein the limiting mechanism comprises a limiting rib and a limiting groove provided in the second cavity, one end of the limiting rib is connected to the protective column, and the other end of the limiting rib extends to the limiting groove;
the protective column comprises a first bushing and a second bushing, the first bushing is rotatably connected to one end of the hourglass enveloping worm, the second bushing is rotatably connected to the other end of the hourglass enveloping worm; and
the first bushing is provided with a first limiting part, the second bushing is provided with a second limiting part, the second limiting part is fixedly connected to the first limiting part to cause the first bushing to rotate with the second bushing, and the first limiting part and the second limiting part form the limiting rib, the limiting rib cooperates with the limiting groove to position the first bushing and the second bushing.

3. The transmission mechanism having the hourglass enveloping worm and the helical gear according to claim 2, wherein the first bushing comprises a first bushing body, a first protrusion connected to the first bushing body, and a second protrusion connected to the first protrusion, the first protrusion and the second protrusion form the first limiting part;
the second bushing comprises a second bushing body, a third protrusion provided at the second bushing body, and a recess provided at the third protrusion, the third protrusion and the recess form the second limiting part; and
the first protrusion is end face-fitted with the third protrusion, and the second protrusion is end face-fitted with the recess.

4. The transmission mechanism having the hourglass enveloping worm and the helical gear according to claim 3, wherein one end of the shell is provided with a receiving cavity communicating with the second cavity, and the second bushing further comprises a fourth protrusion provided at the second bushing body, the fourth protrusion and the third protrusion are provided at opposite sides of the second bushing body, the fourth protrusion cooperates with the receiving cavity to position the second bushing.

5. The transmission mechanism having the hourglass enveloping worm and the helical gear according to claim 4, further comprising
a brushless motor,
wherein the fourth protrusion is provided with a threaded hole, the brushless motor is threadedly connected to the threaded hole, and the brushless motor is drivingly connected to the hourglass enveloping worm to drive the hourglass enveloping worm to rotate.

6. The transmission mechanism having the hourglass enveloping worm and the helical gear according to claim 5, wherein the brushless motor comprises a motor body, an output shaft connected to the motor body, and a threaded post sleeved on the output shaft, the output shaft is drivingly connected to the hourglass enveloping worm, and the threaded post is threadedly connected to the threaded hole.

7. The transmission mechanism having the hourglass enveloping worm and the helical gear according to claim 1, further comprising:
a gear shaft,
wherein the shell is provided with an output hole communicating with the first cavity, the gear shaft is rotatably provided in the output hole, one end of the gear shaft is fixedly connected to the helical gear, and the other end of the gear shaft is exposed on an outside of the shell and is provided with an output portion.

8. The transmission mechanism having the hourglass enveloping worm and the helical gear according to claim 7, wherein a bearing is provided in the output hole, the bearing comprises an inner ring and an outer ring, and the gear shaft passes through the inner ring.

9. The transmission mechanism having the hourglass enveloping worm and the helical gear according to claim 7, further comprising:
a sealing ring,
wherein the sealing ring is provided in the output hole, and the gear shaft passes through the sealing ring.

10. The transmission mechanism having the hourglass enveloping worm and the helical gear according to claim 1, wherein the shell comprises a first shell and a second shell, and the first shell is fixedly connected to the second shell by bolts.
